(19) United States
(12) Patent Application Publication
(10) Pub. No.: US 2025/0155253 A1
(43) Pub. Date: May 15, 2025

(54) STOPOVER RECOMMENDATION METHOD BASED ON REAL-TIME TRAFFIC INFORMATION AND NAVIGATION SYSTEM FOR PERFORMING THE SAME

(71) Applicant: HYUNDAI AUTOEVER CORP., Seoul (KR)

(72) Inventors: Suk Ho LEE, Seoul (KR); Moon Jeong KIM, Seoul (KR); So Jung KIM, Seoul (KR); Yeon Su KIM, Seoul (KR); Won Mi AHN, Seoul (KR); Hwa Hyeon HONG, Seoul (KR)

(21) Appl. No.: 18/944,697

(22) Filed: Nov. 12, 2024

(30) Foreign Application Priority Data
Nov. 14, 2023 (KR) 10-2023-0157677

(51) Int. Cl. G01C 21/34; G01C 21/36

(52) U.S. Cl. CPC G01C 21/3492; G01C 21/3461; G01C 21/3484; G01C 21/3667

(57) ABSTRACT

Stopover recommendation methods and devices are described. According to one embodiment, a method comprises obtaining a traffic information about a first route toward a destination inputted by a user, calculating a driving time zone for which a mobility apparatus of the user will drive along the first route based on the traffic information, determining whether a current time is included in the driving time zone, recommending a stopover based on a user information about the user and the driving time zone when the current time is not included in the driving time zone, displaying a detailed information on the stopover, and determining a second route including the stopover as a final route in response to an approval of the user on the stopover.

### CROSS-REFERENCE TO RELATED APPLICATION

This application claims priority from Korean Patent Application No. 10-2023-0157677 filed on Nov. 14, 2023, in the Korean Intellectual Property Office, and all the benefits accruing therefrom under 35 U.S.C. 119, the contents of which in its entirety are herein incorporated by reference.

### BACKGROUND

### Field

The present disclosure relates to a stopover recommendation method based on real-time traffic information, and a navigation system for performing the same, and more specifically, to a method for calculating an optimal driving time zone for which a vehicle moves to a target destination based on real-time traffic information, and recommending a stopover based on the optimal driving time zone and personal information about a user, and a navigation system for performing the same.

### Description of Related Art

Generally, each of various mobility apparatuses employs a navigation system equipped with a GPS (Global Positioning System) to identify a current location and a current moving speed thereof or to determine a moving speed thereof. The navigation system receives a radio wave indicating a latitude, a longitude, an altitude, etc. from a plurality of artificial satellites, calculates a current location of a moving object to identify the current location of the moving object, and identifies a destination input by a user, and determines a moving route starting from the current location and arriving at the destination.

The navigation system determines the route based on various information related to driving, such as to a distance the destination, an arrival time, a cost such as an optimal distance to the destination, the shortest distance, a traffic condition, use of free or toll road, etc. The navigation system includes not only a component for receiving the destination directly from the user, but also a component that searches for the current location or the surroundings around the destination, and a component that recommends a stopover point.

The navigation system does not simply provide the shortest route for the user to reach the destination. Further, it is important for the navigation system to recommend an appropriate stopover in a situation where the user is expected to arrive at the destination earlier than a scheduled time or in a situation in which traffic congestion is expected when the user currently departs for the destination. In particular, an individualized stopover needs to be recommended to an induvial based on the user's experience, rather than the same stopover being recommended to everyone.

### SUMMARY

A technical purpose to be achieved using embodiments of the present disclosure is to provide a method for calculating an optimal driving time zone for which a vehicle moves to a target destination based on real-time traffic information, and recommending an appropriate stopover which a user may visit before reaching the destination, based on user information when a current time is not included in the calculated optimal driving time zone.

The technical purposes of the present disclosure are not limited to the technical purposes mentioned above, and other technical purposes not mentioned may be clearly understood by those skilled in the art from descriptions as set forth below.

According to an aspect of the present disclosure, a stopover recommendation method may be performed by a computing device, and the method may comprise: obtaining traffic information about a first route toward a destination input by a user; calculating a driving time zone for which a mobility apparatus of the user will drive along the first route, based on the obtained traffic information; determining whether a current time is included in the calculated driving time zone; recommending a stopover based on user information about the user and the calculated driving time zone when the current time is not included in the calculated driving time zone; displaying detailed information on the recommended stopover; and determining a second route including the recommended stopover as a final route, in response to the user's approval with the recommended stopover.

In one embodiment, the traffic information about the first route may include information on accident and traffic control section related to the first route, information on rally and event related to the first route, and weather information related to the first route, and is acquired from an external server.

In one embodiment, the driving time zone for which the mobility apparatus of the user will drive along the first route may be determined such that when the mobility apparatus of the user drives along the first route for the driving time zone, a time required to reach the destination is expected to be the smallest.

In one embodiment, wherein the user information may be extracted from usage history of each of the computing device and the user device of the user, and may include at least one of the user's schedule information, the user's contents viewing history, the user's past destination setting history, and whether the user visits a specific location on a regular basis.

In one embodiment, the stopover may be a first stopover, and the stopover recommendation method may further comprise: determining the first route as the final route when the current time is included in the calculated driving time zone; and recommending a second stopover different from the first stopover, in response to the user not approving the recommended first stopover.

In one embodiment, the recommending of the stopover may further include: obtaining schedule information about the user from the user device of the user; checking whether there is a schedule starting at a timing between the current time and a stating time of the calculated driving time zone; and recommending a location corresponding to the schedule as the stopover, when there is the schedule starting at the timing between the current time and the stating time of the calculated driving time zone.

In one embodiment, the recommending of the stopover may further include: determining recommended contents based on the user's contents viewing history extracted from the user device of the user; recommending a place where the recommended contents is being screened as the stopover when the recommended contents is currently screened contents; and recommending a place at which the user will watch the recommended contents as the stopover when the recommended contents is not currently screened contents.

In one embodiment, the recommending of the place where the recommended contents is being screened as the stopover may include determining whether a distance between the place and the destination is smaller than a threshold.

In one embodiment, the recommending of the stopover may include: obtaining the user's past destination setting history; checking whether there is a place that the user has visited on a regular basis; determining whether a distance between the place that the user has visited on a regular basis and the destination is smaller than a threshold when there is the place that the user has visited on a regular basis; recommending the place that the user has visited on a regular basis as the stopover when the distance between the place that the user has visited on a regular basis and the destination is smaller than the threshold; and recommending another place having a distance to the destination smaller than the threshold and having the same type of the place that the user has visited on a regular basis, when the distance between the place that the user has visited on a regular basis and the destination is equal to or greater than the threshold.

In one embodiment, the detailed information about the recommended stopover may include user information based on which the stopover is recommended, business hours of the recommended stopover, an event that is being held at the recommended stopover, a rating of the stopover, and an expected driving time required to reach the destination when the mobility apparatus of the user drives along the second route including the recommended stopover.

According to another aspect of the present disclosure, a computing device may comprise: a processor; and a memory connected to the process and configured to store therein instructions, wherein when the instructions are executed by the processor, the instructions may cause the processor to perform: obtaining traffic information about a first route toward a destination input by a user; calculating a driving time zone for which a mobility apparatus of the user will drive along the first route, based on the obtained traffic information; determining whether a current time is included in the calculated driving time zone; recommending a stopover based on user information about the user and the calculated driving time zone when the current time is not included in the calculated driving time zone; displaying detailed information on the recommended stopover; and determining a second route including the recommended stopover as a final route, in response to the user's approval with the recommended stopover.

In one embodiment, the traffic information about the first route may include information on accident and traffic control section related to the first route, information on rally and event related to the first route, and weather information related to the first route, and is acquired from an external server.

In one embodiment, the driving time zone for which the mobility apparatus of the user will drive along the first route may be determined such that when the mobility apparatus of the user drives along the first route for the driving time zone, a time required to reach the destination is expected to be the smallest.

In one embodiment, the user information may be extracted from usage history of each of the computing device and the user device of the user, and may include at least one of the user's schedule information, the user's contents viewing history, the user's past destination setting history, and whether the user visits a specific location on a regular basis.

In one embodiment, the stopover may be a first stopover, and wherein when the instructions are executed by the processor, the instructions may cause the processor to further perform: determining the first route as the final route when the current time is included in the calculated driving time zone; and recommending a second stopover different from the first stopover, in response to the user not approving the recommended first stopover.

In one embodiment, the recommending of the stopover may further include: obtaining schedule information about the user from the user device of the user; checking whether there is a schedule starting at a timing between the current time and a stating time of the calculated driving time zone; and recommending a location corresponding to the schedule as the stopover, when there is the schedule starting at the timing between the current time and the stating time of the calculated driving time zone.

In one embodiment, the recommending of the stopover may further include: obtaining recommended contents determined based on the user's contents viewing history extracted from the user device of the user; recommending a place where the recommended contents is being screened as the stopover when the recommended contents is currently screened contents; and recommending a place at which the user will watch the recommended contents as the stopover when the recommended contents is not currently screened contents.

In one embodiment, the recommending of the place where the recommended contents is being screened as the stopover may include determining whether a distance between the place and the destination is smaller than a threshold.

In one embodiment, the recommending of the stopover may include: obtaining the user's past destination setting history; checking whether there is a place that the user has visited on a regular basis; determining whether a distance between the place that the user has visited on a regular basis and the destination is smaller than a threshold when there is the place that the user has visited on a regular basis; recommending the place that the user has visited on a regular basis as the stopover when the distance between the place that the user has visited on a regular basis and the destination is smaller than the threshold; and recommending another place having a distance to the destination smaller than the threshold and having the same type of the place that the user has visited on a regular basis, when the distance between the place that the user has visited on a regular basis and the destination is equal to or greater than the threshold.

In one embodiment, the detailed information about the recommended stopover may include user information based on which the stopover is recommended, business hours of the recommended stopover, an event that is being held at the recommended stopover, a rating of the stopover, and an expected driving time required to reach the destination when the mobility apparatus of the user drives along the second route including the recommended stopover.

### BRIEF DESCRIPTION OF DRAWINGS

The above and other aspects and features of the present disclosure will become more apparent by describing in detail illustrative embodiments thereof with reference to the attached drawings, in which:

FIG. 1 shows an example of an environment to which a navigation system for performing a stopover recommendation method according to an embodiment of the present disclosure may be applied;

FIG. 2 illustrates an example of an initial screen of the navigation system of FIG. 11

FIG. 3 illustrates an example of a route search screen of the navigation system of FIG. 11

FIG. 4 illustrates an example of selecting a stopover recommendation mode on the route search screen of FIG. 3;

FIG. 5 is a flowchart for illustrating an example of a stopover recommendation method according to an embodiment of the present disclosure;

FIG. 6 is a flowchart for illustrating an embodiment of a stopover recommendation step of FIG. 5.

FIG. 7 illustrates an example of a route search screen of FIG. 4 according to an embodiment of FIG. 6;

FIG. 8 is a flowchart illustrating another embodiment of a stopover recommendation step of FIG. 5;

FIGS. 9 to 10 illustrate an example of a route search screen of FIG. 4 according to an embodiment of FIG. 8;

FIG. 11 is a flowchart for illustrating still another embodiment of a stopover recommendation step;

FIG. 12 illustrates an example of the route search screen of FIG. 4 according to an embodiment of FIG. 11; and

FIG. 13 is a block diagram showing a hardware configuration of a computing device for performing the stopover recommendation method according to an embodiment of the present disclosure.

### DETAILED DESCRIPTIONS

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked” between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

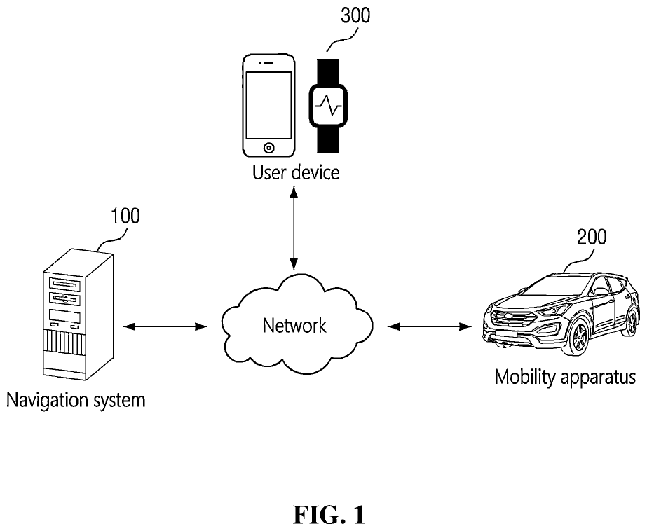

FIG. 1 shows an example of an environment to which a navigation system 100 for performing a stopover recommendation method according to an embodiment of the present disclosure may be applied. The navigation system 100 may calculate a driving time zone for which a vehicle moves to a destination based on real-time traffic information via communication with a mobility apparatus 200 and a user device 300, and may recommend a stopover based on the calculated driving time zone and personalized user information. For the convenience of the description as set forth below, the mobility apparatus 200 is assumed to be the vehicle. However, the present disclosure is not limited thereto.

Specifically, the navigation system 100 according to an embodiment of the present disclosure may display a driving time zone calculated based on a route toward a destination corresponding to a search word entered by a user of the vehicle 200, an expected arrival time when the vehicle will drive along the route, and real-time traffic information. For example, the driving time zone calculated according to an embodiment of the present disclosure may be an optimal driving time zone, that is, a driving time zone with a minimum required driving time to the destination. For example, the real-time traffic information may include information on accidents and control sections, information on rallies and events, weather information, etc., and such information may be stored on any server and provided therefrom to the navigation system 100 through a network. Furthermore, when the current time is not included in the calculated driving time zone (i.e., when the current time is before the calculated driving time zone), the navigation system 100 may suggest to the user to depart at the calculated driving time zone while displaying an expected required driving time to the destination based on the current time.

Furthermore, the navigation system 100 according to an embodiment of the present disclosure may recommend a stopover which the user may stop by before the current time reaches the calculated driving time zone, based on personalized user information. For example, the user information may be extracted from the usage history of the navigation system 100 and the user device 300, and may include the user's schedule information, the user's contents watching history, the user's past destination setting history, and whether or not the user visits a specific location on a regular basis.

That is, according to an embodiment of the present disclosure, when assuming a situation where the user is returning home from a work site, the driving time zone may be calculated based on traffic information from the work site to the home. Since traffic congestion is expected when driving to the home currently, the navigation system may suggest the user to start at the calculated driving time zone. In this regard, an appropriate stopover may be recommended based on the user information. In addition, the appropriate stopover may be recommended in the same way in a situation where a rally or protest is held on the user's driving route and traffic congestion is expected.

For example, the navigation system 100 may check the user's schedule information. When there is a valid schedule, the navigation system 100 may recommend a place corresponding to the schedule as the appropriate stopover. Alternatively, the navigation system 100 may determine contents to be recommended to the user based on the user's contents viewing history, identify whether the determined recommended contents is being screened in the surroundings, and recommend a place (e.g., a movie theater) where the contents is being screened as the stopover when the determined recommended contents is being screened therein. In some cases, even when there is no place that screens the determined recommended contents, and when the user may view the contents through the user device 300 (e.g., through OTT, etc.), the place (e.g., a café) where the user may view the recommended contents may be recommended as the stopover. In addition, the navigation system 100 may check whether there is a place (e.g., a mart, a gym, etc.) that the user has visited on a regular basis based on the user's past destination setting history, and recommend the place or a place similar to the place as the stopover.

In addition to the stopover recommendation, the navigation system 100 may display detailed information about the stopover. The detailed information thereof may include user information indicating that serves as the basis for the stopover recommendation, business hours of the recommended stopover, events that take place at the stopover, ratings of the stopover, and the expected driving time consumed to drive along the route including the recommended stopover. For example, when the navigation system 100 recommends a mart as the stopover, the navigation system 100 may display whether the mart is having a discount event. When the navigation system 100 recommends a movie theater, the navigation system 100 may display the movie theater's showtime. When the navigation system 100 recommends a place corresponding to the schedule, the navigation system 100 may display information related to the schedule (what time the schedule is, who to meet, etc.). After checking the recommended stopover and the related detailed information, the user of the vehicle 200 may determine a route including the stopover as a final route. In one example, the user may determine an existing route to the destination as the final route regardless of the stopover recommendation result. For example, when the current time is included in the calculated driving time zone, the existing route to the destination may be determined as the final route.

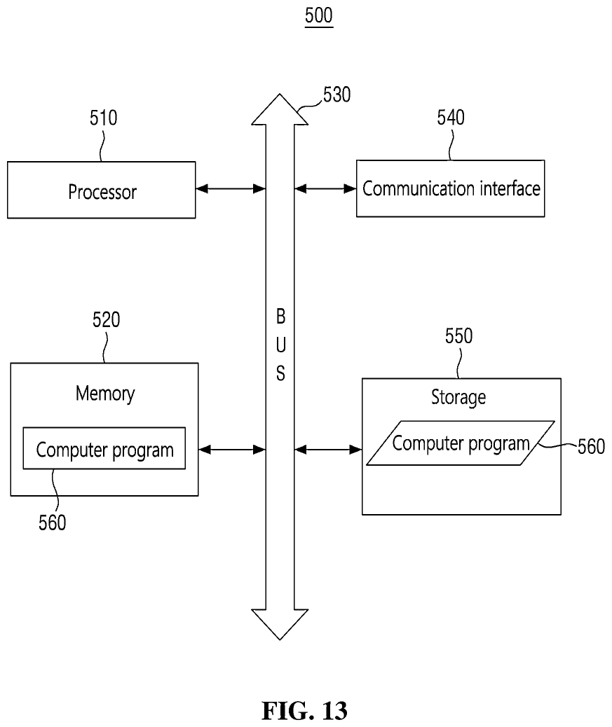

The navigation system 100 according to some embodiments of the present disclosure may be implemented on at least one computing device. For example, all functions of the navigation system 100 may be implemented on one computing device. Alternatively, some functions of the navigation system 100 may be implemented on a first computing device, and the remaining functions thereof may be implemented on a second computing device. Alternative, a specific function of the navigation system 100 may be implemented on a plurality computing devices. For example, a stopover point recommendation function of the navigation system 100 and a function of displaying information about the destination thereof may be implemented separately on different computing devices. The computing device may include any device equipped with a computing means and a communication means. An embodiment in which the navigation system 100 is implemented as a computing device is described in more detail with reference to FIG. 13.

The user device 300 may be any personal computing device used by the user of the vehicle 200. For example, the user device 300 may include a smart phone, a smart watch, a tablet, a desktop, a laptop, etc. However, the present disclosure is not limited thereto, and the user device 300 may be embodied as any computing device equipped with a computing means and a communication means. As described above, the navigation system 100 may communicate with the user device 300 and use usage history stored in the user device 300 as user information.

Furthermore, the components illustrated in FIG. 1 may communicate with each other through a network. For example, the network may be embodied as any type of a wired/wireless network such as a local area network (LAN), a wide area network (WAN), a mobile radio communication network, and Wibro (Wireless Broadband Internet).

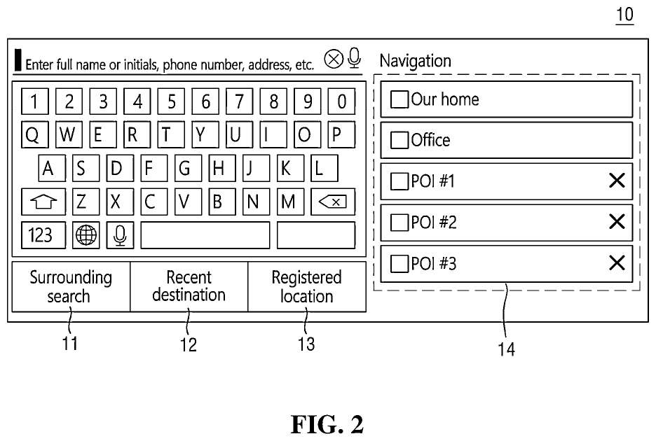

Hereinafter, referring to FIGS. 2 to 4, an user interface of the navigation system 100 is described.

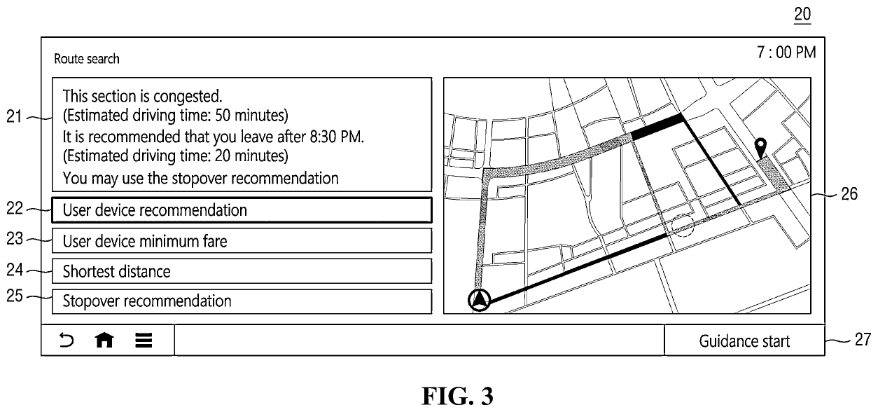

FIG. 2 illustrates an example of an initial screen 10 of the navigation system 100 of FIG. 1. Referring to FIG. 2, the navigation system 100 may receive a search word from a user of the vehicle 200, search for a route for one or more destinations corresponding to the input search word, and display information related to the detected destination on the screen. Referring to FIG. 2, the initial screen 10 displays a surrounding search button 11, a recent destination button 12, and a registered location button 13. When the surrounding search button 11 is pressed, search categories of current location surrounding, destination surrounding, route surrounding, or local area surrounding may be displayed. When the recent destination button 12 is pressed, destinations corresponding to a recently entered search word may be displayed. When the registered location button 13 is pressed, destinations with a high search frequency (e.g., home, office, etc.) may be displayed. For example, locations 14 displayed at the right side of the initial screen 10 as shown in FIG. 2 may be a list of the registered destinations. The following descriptions describe a route search screen displayed after entering the search word or selecting the registered destination with reference to FIG. 3.

FIG. 3 shows an example of a route search screen 20 of the navigation system 100 of FIG. 1. Referring to FIG. 3, a description 21 about a route, recommended routes 22, 23, 24, and 25, a map 26, and a guidance start button 27 are displayed. The description 21 about the route may indicate a traffic situation of the selected route, the expected driving time as required to reach the destination, the calculated optimal driving time zone, etc. The recommended routes include a user device recommendation route 22, a user device minimum fare route 23, and the shortest distance route 24. A stopover recommendation mode 25 may also be used.

Referring to FIG. 2, currently, the user device recommendation route 22 has been selected. The information indicating that a section of interest is congested as of the current time (7:00 PM), and the expected driving time required to reach the destination (50 minutes) when the current time is a departure time are displayed. Further, the optimal driving time zone (after 8:30 PM) as calculated based on traffic information, and the expected driving time required to reach the destination (20 minutes) when the vehicle departs in the calculated driving time zone are displayed. The same type of information as those as described above may be displayed regarding the user device minimum fare route 23 and the shortest distance route 24. In one example, the map 26 displays the selected route. When the guidance start button 27 is pressed, the navigation system 100 may start driving guidance according to the selected route.

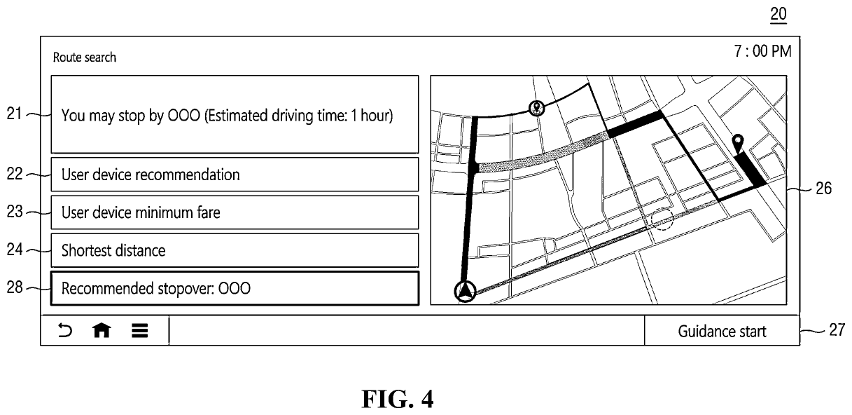

In one example, as shown in FIG. 2, when the current time (7:00 PM) is not included in the calculated driving time zone (after 8:30 PM), the navigation system 10 according to an embodiment of the present disclosure may suggest the stopover recommendation mode 25, and may display related contents in an area of the description 21 about the route (for example, “You may use the stopover recommendation”). Hereinafter, an embodiment of selecting the stopover recommendation mode 25 in the route search screen 20 will be described with reference to FIG. 4.

FIG. 4 shows an embodiment of selecting the stopover recommendation mode 25 in the route search screen 20 of FIG. 3. When the stopover recommendation mode 25 is selected, a description about the stopover may be displayed in the area of the description 21 about the route (for example, “You may stop by OOO”), and a recommended stopover route 28 may be displayed as a recommended route. Then, the selected recommended stopover route 28 may be applied to the map 26. Furthermore, the area of the description 21 about the route may additionally display the optimal driving time zone when using the existing route, the reason why the stopover is recommended, and the expected driving time required to reach the destination when the vehicle stops by the stopover. When the user selects the route including the recommended stopover as the final route, the user may receive guidance on the route upon pressing the guidance start button 27. However, even when the stopover is recommended, it is not necessary to select the route including the stopover as the final route. Alternatively, even when the stopover is recommended, the user may select other recommended routes 22, 23, and 24.

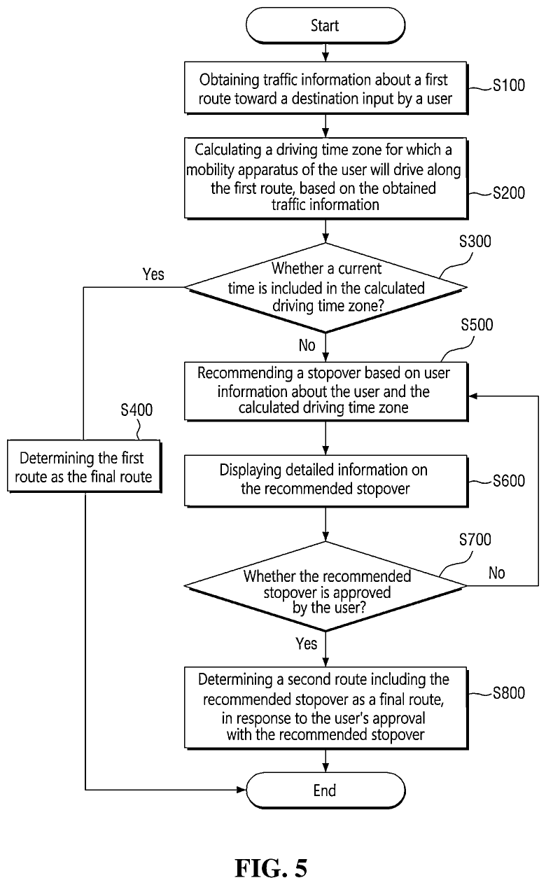

FIG. 5 is a flowchart for illustrating a stopover recommendation method according to an embodiment of the present disclosure. For reference, FIG. 5 shows the operations/steps performed in the navigation system 100 of FIG. 1. Therefore, in the descriptions as set forth below, it may be understood that when a subject of a specific step/operation is omitted, the step/operation is performed in the navigation system 100 of FIG. 1. Furthermore, as described with reference to FIG. 1, the mobility system 200 of FIG. 1 is assumed to be the vehicle. However, the present disclosure is not limited thereto, and the embodiments as described below may be applied to all mobility apparatuses 200 other than vehicles. The following description is made with reference to FIG. 1 to FIG. 4 along with FIG. 5.

In operation S100, traffic information about a first route toward the destination input by the user may be acquired. For example, the traffic information may include information on accidents and traffic control areas, information on rallies and events, weather information, etc., and may be acquired from an external server. In operation S200, the driving time zone for which the vehicle will drive along the first route may be calculated based on the acquired traffic information. For example, the calculated driving time zone may be a time zone for which a time taken to reach the destination is expected to be minimized when driving along the first route. Alternatively, in some cases, the calculated driving time zone may be a time zone starting at the time when the accident has been coped with and the traffic control has been over or the time when the rally and event have been over. Information on the calculated optimal driving time zone may be displayed on the screen of the navigation system 100 as described with reference to FIG. 3.

In operation S300, the navigation system 100 may determine whether the current time is included in the calculated driving time zone. For example, when the current time is included in the calculated driving time zone (YES), the first route may be determined as the final route in operation S400. On the contrary, when the current time is not included in the calculated driving time zone (NO), a stopover may be recommended based on the user information and the calculated driving time zone in operation S500. For example, as described with reference to FIG. 3, when the current time is not included in the calculated driving time zone, the indication that the stopover recommendation may be used may be displayed on the screen of the navigation system 100. When the user decides to use the stopover recommendation, a stopover may be recommended. For example, the user information may be extracted from the usage history of the navigation system 100 and the user device 300, and may include the user's schedule information, the user's contents viewing history, the user's past destination setting history, and whether or not the user visits a specific location on a regular basis.

In operation S600, detailed information about the recommended stopover may be displayed. For example, when a mart is recommended as the stopover, whether there is a discount event at the mart may be displayed. When a movie theater is recommended, the movie theater's showtime may be displayed. When a place corresponding to the user's schedule is recommended, information related to the schedule (what time it is, who to meet, etc.) may be displayed. In operation S700, whether the user approves the recommended stopover may be determined. For example, the user may check the recommended stopover and press the guidance start button on the screen as shown in FIG. 4 to approve the recommended stopover. When the recommended stopover is approved by the user (YES), in operation S800, a second route including the recommended stopover in response to the user's approval may be determined as the final route. In one example, when the recommended stopover is not approved by the user (NO), the process returns to operation S500 inn which a new stopover may be recommended.

In one example, an example in which when the current time is included in the calculated driving time zone, the existing first route is determined as the final route in operations S300 to S400 has been described. However, the present disclosure is not limited thereto. Even when the current time is included in the calculated driving time zone, the user may receive the stopover recommendation and the second route including the stopover may be determined as the final route, according to an embodiment of the present disclosure,

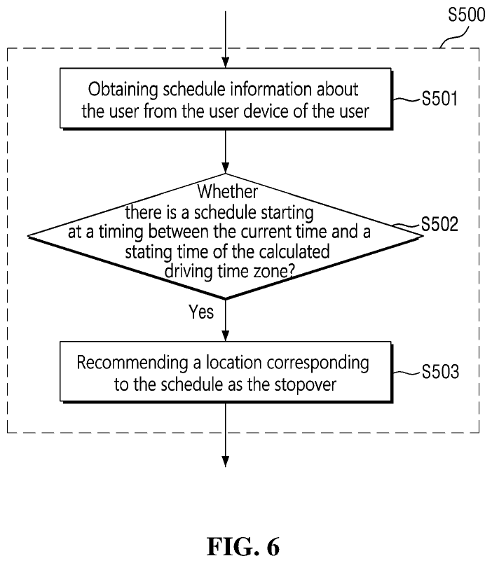

Hereinafter, with reference to FIGS. 6 to 12, various embodiments related to operation S500 will be reviewed. The embodiments as shown in FIGS. 6 to 12 are merely examples. According to an embodiment of the present disclosure, in addition to the user information as described with reference to FIGS. 6 to 12, more various stopovers may be recommended through more various user information.

FIG. 6 is a flowchart for illustrating an embodiment of operation S500 of recommending the stopover of FIG. 5. Referring to FIG. 6, in operation S501, the user's schedule information may be obtained from the user device 300. For example, the user's schedule information may be obtained from a calendar application of the user device 300. Then, in operation S502, the navigation system 100 may check whether there is a schedule starting a time point between the current time and the calculated driving time zone. When there is the schedule starting a time point between the current time and the calculated driving time zone (YES), in operation S503, a place corresponding to the schedule may be recommended as the stopover.

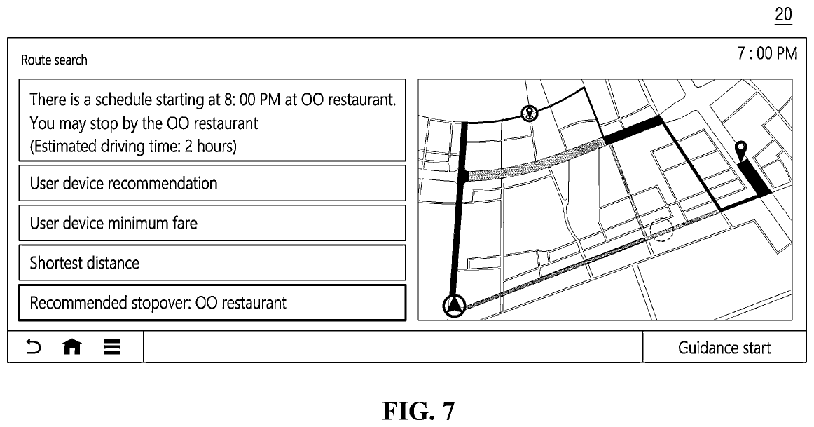

FIG. 7 shows an example of the route search screen 20 of FIG. 4 according to an embodiment of FIG. 6. Referring to FIG. 7, a notification that there is a schedule starting at 8:00 PM between the calculated optimal driving time zone (after 8:30 PM) and the current time (7:00 PM) is displayed in the area of the description 21 about the route. Furthermore, a notification that the user may stop by a place OO restaurant and an estimated required time (2 hours) are displayed. For example, the estimated required time may be calculated based on a time recorded in the calendar application of the user device 300. In this case, the OO restaurant is displayed in a recommended stopover route 28, and a route passing through the OO restaurant is displayed on the map 26. The user may select the route including the OO restaurant as the stopover as the final route by pressing the guidance start button 27.

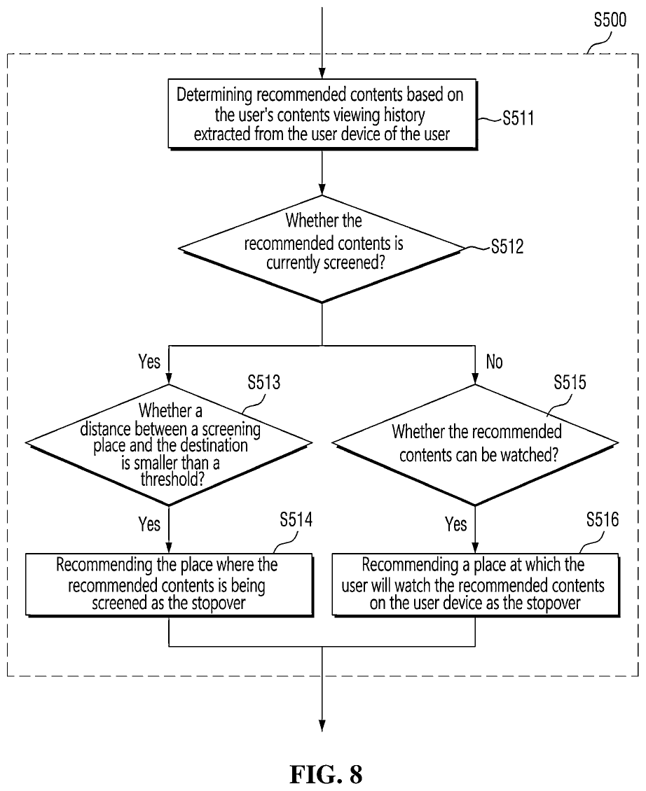

FIG. 8 is a flowchart for illustrating another embodiment of operation S500 of recommending a stopover in FIG. 5.

Referring to FIG. 8, in operation S511, recommended contents determined based on the user's contents viewing history extracted from the user device 300 may be obtained. For example, the contents viewing history may be extracted through the user's OTT application or video streaming application viewing history. The recommended contents may be determined using a recommendation algorithm of the application.

In operation S512, the navigation system 100 may determine whether the determined recommended contents is currently screened contents (for example, a currently showing movie when the recommended contents is a movie). When the determined recommended contents is being currently screened (YES), in operation S513, the navigation system 100 may determine whether a distance between the destination and a screening location is smaller than a threshold. When the distance is smaller than the threshold (YES), in operation S514, the location (e.g., a movie theater) that is screening the recommended contents may be recommended as the stopover. In one example, when the contents is not a currently screening contents (e.g., not a currently screening movie) or is not of a type of contents that is screened at a specific location, such as a drama or entertainment show (NO), in operation S515, the navigation system 100 may determine whether the recommended contents can be watched. When the recommended contents can be watched (YES), in operation S516, a place at which the user watches the recommended contents on the user device 300 may be recommended as the stopover. For example, in this case, the stopover that may be recommended may include a cafe where the user may watch the OTT on the user device.

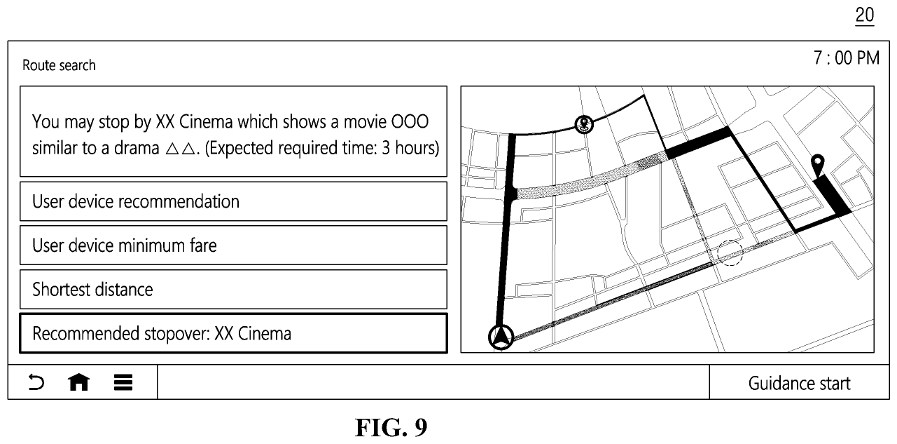

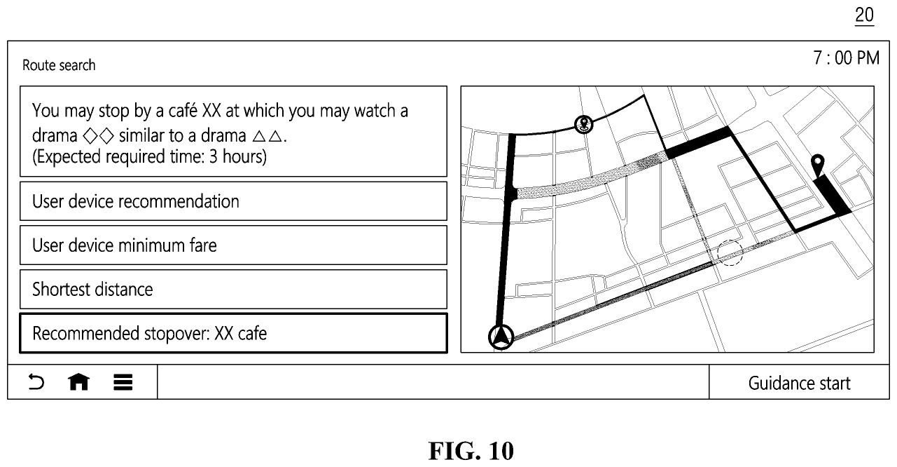

FIG. 9 to FIG. 10 illustrate the route search screen 20 of FIG. 4 according to an embodiment of FIG. 8. First, FIG. 9 is an embodiment that shows the case where the recommended contents is a currently showing movie, and FIG. 10 is an embodiment that shows the case where the recommended contents is a drama. It is assumed that the drama AA may be extracted as the contents that the user likes from the user device 300, and based on this extraction result, the movie OOO has been recommended in FIG. 9, and the drama has been recommended in FIG. 10. In the area of the description 21 about the route in FIG. 9, the notification that the user may stop by the XX movie theater showing the movie OOO may be displayed. In this regard, the XX movie theater is displayed in the recommended stopover route 28. In the area of the description 21 about the route in FIG. 10, the notification that the user may stop by the XX cafe at which the user may watch the drama In this regard, the XX cafe may be displayed in the recommended stopover route 28. For example, the expected required time (3 hours) in FIGS. 9 and 10 may be calculated based on the playback time of the recommended contents and the business hours of the movie theater or cafe. The user may select a route including the stopover, that is, the XX movie theater or XX cafe as the final route by pressing the guidance start button 27.

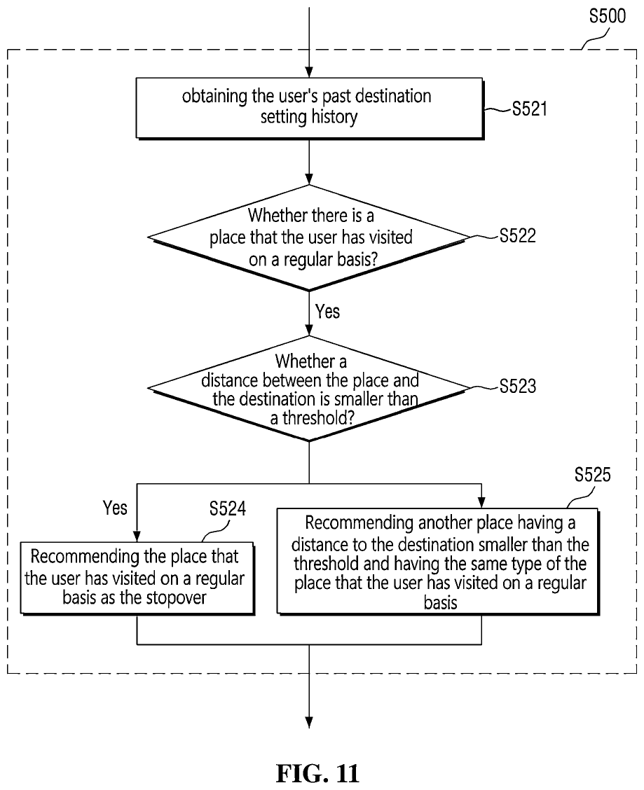

FIG. 11 is a flow chart for illustrating still another embodiment of operation S500 of recommending a stopover in FIG. 5. Referring to FIG. 11, in operation S521, the user's past destination setting history may be acquired in the navigation system 100. In operation S522, the navigation system 100 may determine whether there is a place that the user visits on a regular basis based on the history. For example, the place that the user visits on a regular basis may include a large mart that the user visits once every two weeks, and a gym that the user visits once every two days, etc. In this case, when there is the place that the user visits on a regular basis (YES), in operation S523, the navigation system 100 may determine whether a distance to the destination is smaller than a threshold. When the distance is smaller than the threshold (YES), in operation S524, the place that the user visited on a regular basis may be recommended as the stopover. On the contrary, when the distance to the destination is greater than or equal to the threshold (NO), in operation S525, a place having a distance to the destination smaller than the threshold and having the same type of the place that the user visited on a regular basis may be recommended as the stopover.

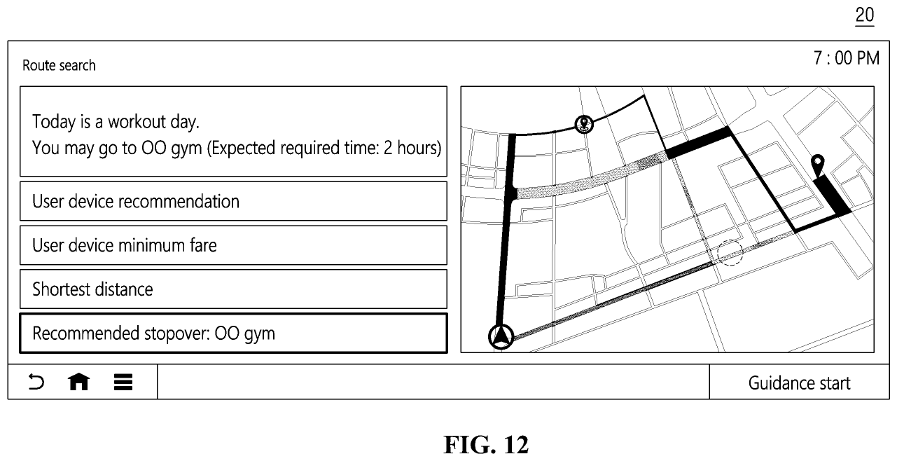

FIG. 12 shows an example of the route search screen 20 of FIG. 4 according to an embodiment of FIG. 11. For example, it is assumed that the user visits an exercise facility (e.g., OO gym) on a regular basis, and the embodiment of FIG. 12 is a screen of the navigation system 100 on a day when the user visits the facility. Referring to FIG. 12, a notification that today is an exercise day is displayed in in the area of the description 21 about the route, and a notification that the user may pass through a related location (OO gym) and an estimated required time (2 hours) are displayed. For example, the estimated required time may be calculated based on the user's behavioral pattern or heart rate obtained from the user device 300. In this case, the OO gym is displayed in the recommended stopover route 28, and a route passing through the OO gym is displayed on the map 26. The user may select the route including the OO gym as a final route by pressing the guidance start button 27. FIG. 12 shows a case where a distance between the OO gym as a place that the user visits regularly and the destination is smaller than a threshold value. However, as described with reference to FIG. 11, when the distance between OO gym and the destination is greater than or equal to the threshold value, another gym with a distance to the destination smaller than the threshold value may be recommended.

FIG. 13 is a block diagram showing a hardware configuration of a computing device 500 for performing the stopover recommendation method according to an embodiment of the present disclosure.

Referring to FIG. 13, the computing device 500 may include one or more processors 510, a bus 530, a communication interface 540, a memory 520 that loads a computer program executed by the processor 510 therein, and a storage 550 that stores a computer program 560 therein. However, only components related to an embodiment of the present disclosure are illustrated in FIG. 11. Therefore, a person skilled in the art in the technical field to which the present disclosure belongs may understand that other general components than the components as illustrated in FIG. 11 may be included in the computing device.

In other words, the computing device 500 may include various components in addition to the components as illustrated in FIG. 11. Furthermore, in some cases, the computing device 500 may be configured such that some of the components as illustrated in FIG. 11 are omitted. Hereinafter, each of the components of the computing device 500 is described.

The processor 510 may control all operations of the components of the computing device 500. The processor 510 may be configured to include at least one of a CPU (Central Processing Unit), an MPU (Micro Processor Unit), an MCU (Micro Controller Unit), a GPU (Graphics Processing Unit), or any further type of a processor well known in the technical field of the present disclosure. Furthermore, the processor 510 may perform computations of at least one application or program for executing operations/methods according to some embodiments of the present disclosure. The computing device 500 may have one or more processors.

Next, the memory 520 may store therein various data, commands, and/or information. The memory 520 may load therein the computer program 560 from the storage 550 to execute operations/methods according to some embodiments of the present disclosure. The memory 520 may be embodied as a volatile memory such as RAM. However, the present disclosure is not limited thereto.

Next, the bus 530 may provide a communication function between the components of the computing device 500. The bus 530 may be embodied as various types of buses such as an address bus, a data bus, and a control bus.

Next, the communication interface 540 may support wired and wireless Internet communication of the computing device 500. Furthermore, the communication interface 540 may support various communication schemes other than Internet communication. To this end, the communication interface 540 may be configured to include a communication module well known in the technical field of the present disclosure.

Next, the storage 550 may non-temporarily store therein one or more computer programs 560. The storage 550 may be configured to include a non-volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the art to which the present disclosure belongs.

Next, the computer program 560 may include one or more instructions that cause the processor 510 to perform the operations/methods according to various embodiments of the present disclosure when being loaded into the memory 520. That is, the processor 510 may execute one or more loaded instructions to perform the operations/methods according to various embodiments of the present disclosure.

For example, the computer program 560 may include instructions for obtaining traffic information about a first route toward a destination input by a user; instructions for calculating a driving time zone for which a mobility apparatus of the user will drive along the first route, based on the obtained traffic information; instructions for determining whether a current time is included in the calculated driving time zone; instructions for recommending a stopover based on user information about the user and the calculated driving time zone when the current time is not included in the calculated driving time zone; instructions for displaying detailed information on the recommended stopover; and instructions for determining a second route including the recommended stopover as a final route, in response to the user's approval with the recommended stopover.

According to the embodiment of the present disclosure, an appropriate stopover that is personalized to the user may be recommended during rush hour or other times when traffic is congested. The driving experience of the user to the target destination may be more convenient. In particular, according to an embodiment of the present disclosure, the stopover is recommended based on the user's usual activities or schedules. Thus, there is a higher possibility that meaningful stopovers may be recommended to the user, compared to when an algorithm that simply recommends a place surrounding the current location or the destination as the stopover is used. Furthermore, when using the functions of destination search and route guidance, the one-way user experience of the navigation system may be expanded into a mutually complementary user experience.

Various embodiments and the effects thereof according to the present disclosure have been mentioned with reference to FIGS. 1 through 13. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A stopover recommendation method performed by a computing device, the method comprising:
obtaining a traffic information about a first route toward a destination inputted by a user;
calculating a driving time zone for which a mobility apparatus of the user will drive along the first route based on the traffic information;
determining whether a current time is included in the driving time zone;
recommending a stopover based on a user information about the user and the driving time zone when the current time is not included in the driving time zone;
displaying a detailed information on the stopover; and
determining a second route including the stopover as a final route in response to an approval of the user on the stopover.

2. The stopover recommendation method of claim 1, wherein the traffic information about the first route includes an information on an accident and a traffic control section related to the first route, an information on a rally and event related to the first route, and a weather information related to the first route, and the traffic information about the first route is acquired from an external server.

3. The stopover recommendation method of claim 1, wherein the driving time zone for which the mobility apparatus of the user will drive along the first route is determined such that when the mobility apparatus of the user drives along the first route for the driving time zone, a time required to reach the destination is expected to be the shortest.

4. The stopover recommendation method of claim 1, wherein the user information is extracted from a usage history of each of the computing device and a user device of the user, and the user information includes a schedule information of the user, a contents viewing history of the user, a past destination setting history of the user, or whether the user visits a specific location on a regular basis.

5. The stopover recommendation method of claim 1, wherein the stopover is a first stopover, and
wherein the stopover recommendation method further comprises:
determining the first route as the final route when the current time is included in the driving time zone; and
recommending a second stopover different from the first stopover in response to the user not approving the first stopover.

6. The stopover recommendation method of claim 1, wherein the recommending of the stopover further includes:
obtaining a schedule information about the user from a user device of the user;
checking whether there is a schedule starting at a timing between the current time and a stating time of the driving time zone; and
recommending a location corresponding to the schedule as the stopover when there is the schedule starting at the timing between the current time and the stating time of the driving time zone.

7. The stopover recommendation method of claim 1, wherein the recommending of the stopover further includes:
determining recommended contents based on a contents viewing history of the user extracted from the user device of the user;
recommending a place where the recommended contents are being screened as the stopover when the recommended contents are still showing; and
recommending a place at which the user will watch the recommended contents as the stopover when the recommended contents are no longer at theaters.

8. The stopover recommendation method of claim 7, wherein the recommending of the place where the recommended contents are being screened as the stopover includes determining whether a distance between the place and the destination is shorter than a threshold.

9. The stopover recommendation method of claim 1, wherein the recommending of the stopover includes:
obtaining apast destination setting history of the user;
checking whether there is a place that the user has visited on a regular basis;
determining whether a distance between the place that the user has visited on the regular basis and the destination is shorter than a threshold when there is the place that the user has visited on the regular basis;
recommending the place that the user has visited on the regular basis as the stopover when the distance between the place that the user has visited on the regular basis and the destination is shorter than the threshold; and
recommending another place having a distance to the destination shorter than the threshold and having a same type of the place that the user has visited on the regular basis when the distance between the place that the user has visited on the regular basis and the destination is equal to or longer than the threshold.

10. The stopover recommendation method of claim 1, wherein the detailed information about the stopover includes the user information based on the stopover recommended, business hours of the stopover, an event that is being held at the stopover, a rating of the stopover, and an expected driving time required to reach the destination when the mobility apparatus of the user drives along the second route including the stopover.

11. A computing device comprising:
a processor; and
a memory connected to the process and configured to store therein instructions,
wherein when the instructions are executed by the processor, the instructions cause the processor to perform:
obtaining a traffic information about a first route toward a destination inputted by a user;
calculating a driving time zone for which a mobility apparatus of the user will drive along the first route based on the traffic information;
determining whether a current time is included in the driving time zone;
recommending a stopover based on a user information about the user and the driving time zone when the current time is not included in the driving time zone;
displaying a detailed information on the stopover; and
determining a second route including the stopover as a final route in response to an approval of the user on the stopover.

12. The computing device of claim 11, wherein the traffic information about the first route includes an information on an accident and a traffic control section related to the first route, an information on a rally and an event related to the first route, and a weather information related to the first route, and the traffic information about the first route is acquired from an external server.

13. The computing device of claim 11, wherein the driving time zone for which the mobility apparatus of the user will drive along the first route is determined such that when the mobility apparatus of the user drives along the first route for the driving time zone, a time required to reach the destination is expected to be the shortest.

14. The computing device of claim 11, wherein the user information is extracted from a usage history of each of the computing device and a user device of the user, and the user information includes a schedule information of the user, a contents viewing history of the user, a past destination setting history of the user, or whether the user visits a specific location on a regular basis.

15. The computing device of claim 11, wherein the stopover is a first stopover, and
wherein when the instructions are executed by the processor, the instructions cause the processor to further perform:
determining the first route as the final route when the current time is included in the driving time zone; and
recommending a second stopover different from the first stopover, in response to the user not approving the first stopover.

16. The computing device of claim 11, wherein the recommending of the stopover further includes:
obtaining a schedule information about a user from the user device of the user;
checking whether there is a schedule starting at a timing between the current time and a stating time of the driving time zone; and
recommending a location corresponding to the schedule as the stopover, when there is the schedule starting at the timing between the current time and the stating time of the driving time zone.

17. The computing device of claim 11, wherein the recommending of the stopover further includes:
obtaining recommended contents determined based on a contents viewing history of the user extracted from the user device of the user;
recommending a place where the recommended contents are being screened as the stopover when the recommended contents are still showing; and
recommending a place at which the user will watch the recommended contents as the stopover when the recommended contents are no longer at theaters.

18. The computing device of claim 17, wherein the recommending of the place where the recommended contents are being screened as the stopover includes determining whether a distance between the place and the destination is shorter than a threshold.

19. The computing device of claim 11, wherein the recommending of the stopover includes:
obtaining a past destination setting history of the user;
checking whether there is a place that the user has visited on a regular basis;
determining whether a distance between the place that the user has visited on the regular basis and the destination is shorter than a threshold when there is the place that the user has visited on the regular basis;
recommending the place that the user has visited on the regular basis as the stopover when the distance between the place that the user has visited on the regular basis and the destination is shorter than the threshold; and
recommending another place having a distance to the destination shorter than the threshold and having a same type of the place that the user has visited on the regular basis when the distance between the place that the user has visited on the regular basis and the destination is equal to or longer than the threshold.

20. The computing device of claim 11, wherein the detailed information about the stopover includes the user information based on the stopover recommended, business hours of the stopover, an event that is being held at the stopover, a rating of the stopover, and an expected driving time required to reach the destination when the mobility apparatus of the user drives along the second route including the stopover.
